(19) United States
(12) Patent Application Publication
(10) Pub. No.: US 2020/0315400 A1
(43) Pub. Date: Oct. 8, 2020

(54) A COOKER

(71) Applicant: Shriro Australia Pty Limited, Kingsgrove (AU)

(72) Inventors: David Paul Mansueto, Rose Bay (AU); Lee Blattmann, Castle Cove (AU); YaoBin Li, Rhodes (AU); Samuel James Weise, Maitland Vale (AU); David Andrew Jones, Beecroft (AU)

(21) Appl. No.: 16/768,383

(22) PCT Filed: Nov. 30, 2018
(86) PCT No.: PCT/AU2018/000242

§ 371 Date: May 29, 2020

(30) Foreign Application Priority Data
Nov. 30, 2017 (AU) 2017904844

(51) Int. Cl. A47J 37/07; F24B 1/02; F24C 15/34; F24B 13/02; F24B 15/00; F23Q 7/02; F24B 1/26; F24B 13/00; F24B 13/04; F24C 15/08; A47J 36/32; A47J 36/34; A47J 36/36; A47J 36/10; A23B 4/052

(52) U.S. Cl. CPC A47J 37/0709; A23V 2002/00; F24C 15/34; F24B 13/02; F24B 15/005; F23Q 7/02; F24B 1/26; F24B 13/004; F24B 13/04; F24C 15/08; A47J 37/079; A47J 36/321; A47J 36/34; A47J 36/36; A47J 36/10; A23B 4/052; A47J 2202/00; F24B 1/028

(57) ABSTRACT

A solid-fuel cooker, such as a barbecue, oven, or smoker for outdoor use, comprising a body enclosing a fuel chamber configured to act as a firebox for combustion of solid fuel, such as wood, charcoal or briquettes. The fuel is supported within the chamber on a fuel support and a cooking zone is spaced above the fuel chamber for receiving food items to be cooked. The body comprises an outer shell forming an exterior housing of the cooker, and an inner shell encompassing the fuel chamber, wherein the inner shell is housed within the outer shell and is spaced from the outer shell to thermally isolate or insulate the fuel chamber from the exterior housing of the cooker.

### CROSS REFERENCE TO RELATED APPLICATIONS

The present application claims priority from Australian Provisional Patent Application No. 2017904844 filed on 3, Nov. 2017 the contents of which is incorporated herein by reference.

### FIELD OF THE INVENTION

The present invention relates to a cooker, and especially to a solid-fuel cooker, such as a barbecue, an oven, or a smoker, for outdoor use.

It will be appreciated that the invention has application to a range of different types of cookers that use solid fuels, such as wood chips, charcoal or briquettes. These cookers include, but are not limited to, barbecues, grills, smokers, outdoor ovens, pizza ovens, and the like, and it will be convenient to describe the invention herein in this exemplary context.

### BACKGROUND OF THE INVENTION

Barbecues that are designed to use solid fuel, such as charcoal or briquettes, to cook food have been known for many years. Typically, such barbecues have a chamber called a firebox for accommodating the solid fuel during combustion and a cooking grating or grille disposed above the firebox so that the heat generated by the combustion of the solid fuel in the firebox is transferred to the cooking grille. The present Applicant has made numerous recent developments in the field of barbecues, one of which concerns a barbecue with spit functionality as described in International Patent Application No. PCT/AU2016/000345. Nevertheless, efforts are continually being made to provide an improved solid-fuel cooker for outdoor use.

### SUMMARY OF THE INVENTION

In view of the above, it is an object of the present invention to provide a new solid-fuel cooker, such as a barbecue, oven, or smoker for outdoor use, that substantially overcomes or at least ameliorates one or more disadvantages of known solid-fuel cookers.

According to one aspect, the present invention provides a cooker, and especially a solid-fuel cooker, such as a barbecue, oven, or smoker for outdoor use. The cooker comprises: a body having or enclosing a fuel chamber configured to act as a firebox for combustion of solid fuel, such as wood, charcoal or briquettes; a fuel support for supporting the solid fuel in the fuel chamber; and a cooking zone spaced above the fuel chamber for receiving food items to be cooked. The body comprises an outer shell forming an exterior housing of the cooker, and an inner shell encompassing the fuel chamber, wherein the inner shell is housed within the outer shell and is spaced from the outer shell to thermally isolate or insulate the fuel chamber from the exterior housing of the cooker.

In a preferred embodiment, the inner shell is spaced from the outer shell over at least about 90 percent, and preferably substantially all, of its outer surface area to thermally isolate or insulate the fuel chamber from the exterior housing of the cooker. In this regard, an air gap is typically provided between the inner shell and the outer shell by the spaced arrangement. The spacing or air gap is preferably at least about 5 mm, and more preferably at least about 10 mm. The spacing or air gap between the inner shell and the outer shell may be at least partially filled with a suitable thermal insulation material, which may be rated to temperatures in the range of 200° C. to 500° C., depending on the location at which it is provided. The inner shell may have the form of a tub or basin and be supported within the outer shell at and/or along an upper rim or peripheral edge thereof and/or at or along a periphery of a base thereof. Preferably, the upper rim or peripheral edge of the inner shell is supported at and/or along an upper rim or peripheral edge of the outer shell. Further, the inner shell preferably includes or houses a fuel support structure which may be configured as a receptacle, such as a basin or a tray, for holding the solid fuel. In this regard, the fuel chamber may have an upper opening or be upwardly open for introducing the solid fuel onto the fuel support structure from above.

In a preferred embodiment, the cooker comprises an ignition system for igniting solid fuel supported in the fuel chamber. The ignition system comprises at least one electric heating element mounted within the body for heating solid fuel supported in the fuel chamber. To this end, the at least one electric heating element is located in or adjacent the fuel chamber within the inner shell, and preferably below and/or in contact with the fuel support structure, e.g. formed as a receptacle, such as a basin or a tray, for holding the solid fuel.

According to another aspect, the present invention provides a cooker, and especially a solid-fuel cooker, such as a barbecue, oven, or smoker for outdoor use. The cooker comprises: a body having or enclosing a fuel chamber configured to act as a firebox for combustion of solid fuel, such as wood, charcoal or briquettes; a fuel support for supporting the solid fuel in the fuel chamber; a cooking zone spaced above the fuel chamber for receiving food items to be cooked; an electric ignition system for igniting solid fuel supported in the fuel chamber, the ignition system having at least one electric heating element mounted within the body for heating solid fuel supported in the fuel chamber; and an electronic control system for controlling and/or monitoring operation of the cooker.

In a preferred embodiment, the control system is operatively connected to the ignition system and desirably configured to deactivate the at least one electric heating element after a predetermined period of time has elapsed following its activation, and/or if the temperature exceeds a predetermined threshold. The predetermined period of time may be in the range of about 2 minutes to about 20 minutes, preferably in the range of about 5 minutes to about 15 minutes, and more preferably in the range of about 5 minutes to about 10 minutes.

In a preferred embodiment, the cooker comprises an electric cable for connection to an electrical power supply socket to supply electrical energy to the at least one heating element of the ignition system, and optionally also to the electronic control system. Preferably, however, the electronic control system has a separate power supply, e.g. via a battery. The electric cable is preferably wound on a spool in the body of the cooker. The cable spool may have a torsional bias for retracting the cable when not in use. The spool is preferably housed in the body of the cooker below the fuel chamber, and preferably in the space between the inner shell and the outer shell. Heat shielding is preferably provided around the cable spool to prevent heat damage to the cable during use of the cooker.

In a preferred embodiment, the cooker comprises a hood which is connected to the body and movable between a closed position in which it covers and/or encloses the cooking zone, and an open position in which the cooking zone is substantially uncovered to provide access thereto. Like the body, the hood preferably comprises a hood outer shell that forms part of the exterior housing of the cooker, and a hood inner shell for covering and/or enclosing the cooking zone. In this way, the hood inner shell is generally spaced from the hood outer shell to thermally isolate or insulate the cooking zone from the exterior housing of the cooker. This spaced arrangement of the hood inner shell and the hood outer shell typically provides an air gap between them. The spacing or air gap is preferably at least about 5 mm, and more preferably at least about 10 mm. The hood inner shell may be spaced from the hood outer shell over at least about 90 percent, and preferably substantially all, of its outer surface area to thermally isolate or insulate the exterior housing of the cooker from the cooking zone. The spacing or air gap between the hood inner shell and the hood outer shell may be at least partially filled with a suitable thermal insulation material, which may be rated to temperatures in the range of 200° C. to 500° C. In the closed position, the hood outer shell preferably forms a continuous outer profile with the outer shell of the body. Preferably, the hood inner shell is domed and is supported within the hood outer shell at and/or along a lower peripheral rim or peripheral edge thereof. Preferably, the lower rim or peripheral edge of the hood inner shell is supported at and/or along a lower rim or peripheral edge of the hood outer shell.

In a preferred embodiment, the cooker includes one or more temperature sensors for sensing the temperature of particular parts of the cooker. For example, the cooker may include one or more temperature sensors incorporated in the body of the cooker and/or one or more temperature sensors incorporated in the hood of the cooker. In a particularly preferred example, two temperature sensors or probes may be incorporated or fixed in the hood for sensing the temperature in the cooking zone. Furthermore, the cooker may include one or more additional temperature sensors or probes which are moveable (i.e. non-fixed) and can be employed on food items. The temperature sensors are operatively associated with, and/or communicate with, the control system, which is configured to monitor the temperature sensed by each temperature sensor and provide information from the sensors to the user; e.g. via a display device.

In a preferred embodiment, the control system of the cooker is configured to transfer data to, or to communicate with, a personal electronic device of a user, such as a mobile phone or a tablet. For example, the control system of the cooker may have Bluetooth™ functionality (e.g. via a Bluetooth™ chip provided in the circuitry of the control system) for relay of data to a personal electronic device of the user. The relay of data could, for example, only be one-way. The data may thus be relayed to a user's phone or tablet to allow the user to monitor ambient temperature(s), cooker temperature(s) and/or food temperature(s) remotely, typically within about a 50 m radius. In other words, a user may be temporarily inside the home or otherwise away from the cooker and yet still closely monitor changes in the conditions of the cooker itself and/or of the food items in the cooking zone.

In a preferred embodiment, the hood of the cooker includes a lamp to provide light for operation in dark conditions, as are typical at twilight or nighttime. The lamp will typically be rated to withstand high temperatures (e.g. up to about 500° C.). The lamp may be configured for manual operation by a user, e.g. via a manual on/off switch on the body of the cooker, or by an automatic switch activated when the hood is moved into the open position, or it may be operated via the electronic control system.

In a preferred embodiment, the hood comprises a chimney assembly having a rotatable control member that is operable to progressively open or close one or more outlet vent apertures in the chimney assembly. The chimney assembly may include a cap that is rotatable via the control member to progressively open or close the one or more outlet vent apertures provided in lateral sides of the chimney assembly below the cap. The control member may be or may comprise a handle extending from the cap which is rotatable through an angle of up to about 360 degrees, and preferably of about 180 degrees. The rotatable control member may be calibrated or marked to provide the user with a clear indication of the degree or extent to which the outlet vent apertures are opened or closed.

In a preferred embodiment, the cooker further comprises an internal latch mechanism for securing the hood in the closed position. In this way, the cooker may be configured such that movement of the hood to the open position requires two-handed operation; namely, one hand to disengage the latch mechanism and one hand to lift or move the hood simultaneously with disengagement of the latch mechanism. Such an internal latch mechanism can provide an important child-safety function, as the latch mechanism itself is substantially hidden from view and a child cannot simply lift or open the hood of the cooker without also disengaging the latch mechanism at the same time. The latch mechanism preferably includes an actuator, preferably in the form of resiliently biased button, for disengaging the latch mechanism to release the hood for opening. Even if a child were to locate the actuator, the coordination required to operate both the actuator and the hood simultaneously is beyond the capability of most small children. Furthermore, the resilient bias applied to the actuator can be selected to be beyond the strength of most small children for successful operation. In addition to the above, however, the latch mechanism securing the hood and the two-stage hood opening operation that it provides can reduce the risk of injury during use of the cooker. In particular, the secure hood and the more complicated opening procedure may function to reduce the risk of ‘flashbacks’ or ‘backdrafts’ that can occur if a user opens the hood quickly. In other words, the user is required to take more time and more care in opening the hood of the cooker in this embodiment.

In a preferred embodiment, the body of the cooker includes a fuel loading port that includes a first re-fueling opening formed through a side wall of the outer shell and providing access to the fuel chamber for introducing solid fuel into the fuel chamber during operation of the cooker. The fuel loading port includes a removable closure for closing the first re-fueling opening when the fuel loading port is not in use. The fuel loading port preferably includes a second re-fueling opening formed through a side wall of the inner shell and aligned with the first re-fueling opening in the side wall of the outer shell for access to the fuel chamber. Thus, the closure may be configured to be inserted into the fuel loading port to close both the first re-fueling opening as well as the second re-fueling opening when the fuel loading port is not in use.

In a preferred embodiment, the body of the cooker further includes an air inlet assembly having a rotatable control member that is operable to progressively open or close one or more inlet vent apertures in a side wall of the outer shell for providing airflow to the fuel chamber. The air inlet assembly preferably includes an airflow duct or channel formed between the outer shell and the inner shell and providing communication between the one or more inlet vent apertures and the fuel chamber. The rotatable control member is preferably provided as a cap or closure which covers an end of the airflow channel at the side wall of the outer shell and this control member is preferably rotatable through an angle of up to about 360 degrees, preferably about 180 degrees, to progressively open or close the one or more inlet vent apertures. In a generally similar manner as with the chimney assembly, the rotatable control member of the air inlet assembly is preferably calibrated and/or marked in order to provide the user with a clear indication of the degree or extent to which the inlet vent apertures are opened or closed.

In a preferred embodiment, the cooker further comprises a base unit for supporting and elevating the body of the cooker. The base unit preferably includes one or more recesses on an upper surface thereof for receiving respective footings provided externally on a bottom of the body. The one or more recesses preferably include locking means for locking engagement with the respective footings of the body to securely lock the body to the base unit. The base unit may include one or more legs for supporting and elevating the body of the cooker on an outdoor surface, such as a terrace or patio. Furthermore, the base unit may include at least one drawer or a cupboard for storing cooking utensils. The at least one drawer may be configured to operate the locking means when the body of the cooker is mounted on the base, the locking means preferably comprising a latch mechanism.

### BRIEF DESCRIPTION OF DRAWINGS

For a more complete understanding of the present invention and the advantages thereof, exemplary embodiments of the invention will be explained in detail in the following description with reference to the accompanying drawings, in which like reference signs designate like parts, and in which:

FIG. 1 is a top view of a cooker according to a preferred embodiment;

FIG. 2 is a front view of the cooker shown in FIG. 1;

FIG. 3 is a perspective cross-sectional view of the cooker shown in FIG. 1 taken in the direction of the arrows

FIG. 4 is a perspective cross-sectional view of the cooker shown in FIG. 1 taken in the direction of the arrows IV-IV;

FIG. 5 is a more detailed perspective cross-sectional view of the chimney of the cooker shown in FIG. 4;

FIG. 6 is a perspective view of a base unit for a cooker of a preferred embodiment with the cooker securing mechanism in a locked state;

FIG. 7 is a perspective view of the base unit shown in FIG. 6 with the cooker securing mechanism in an unlocked state;

FIG. 8 is a perspective view of a cooker according to another preferred embodiment;

FIG. 9 is a perspective view of the cooker shown in FIG. 8 with the hood in an open position;

FIG. 10 is a cross-sectional view of a hood latching mechanism of the cooker shown in FIG. 8, with the hood in the closed position and the latch mechanism latched;

FIG. 11 is a more detailed cross-sectional view of the hood latching mechanism shown in FIG. 10, with the hood in the closed position and the latch mechanism latched;

FIG. 12 is a more detailed cross-sectional view of the hood latching mechanism shown in FIG. 10, with the hood in the closed position and the latch mechanism unlatched;

FIG. 13 is a top view of the cooker shown in FIG. 8;

FIG. 14 is a perspective cross-sectional view of the cooker shown in FIG. 13 taken in the direction of the arrows XIV-XIV;

FIG. 15 is a perspective cross-sectional view of the cooker shown in FIG. 13 taken in the direction of the arrows XV-XV;

FIG. 16 is a top view of a temperature probe in accordance with the invention;

FIG. 17 is a detailed underside view of the hood showing the temperature probe connection ports; and

FIG. 18a is a detail cutaway side view of the hood showing the temperature probe connection ports and temperature probes.

The accompanying drawings are included to provide a further understanding of the present invention and are incorporated in and constitute a part of this specification. The drawings illustrate particular embodiments of the invention and together with the description serve to explain the principles of the invention. Other embodiments of the invention and many of the attendant advantages of the invention will be readily appreciated as they become better understood with reference to the following detailed description.

### DESCRIPTION OF PREFERRED EMBODIMENTS

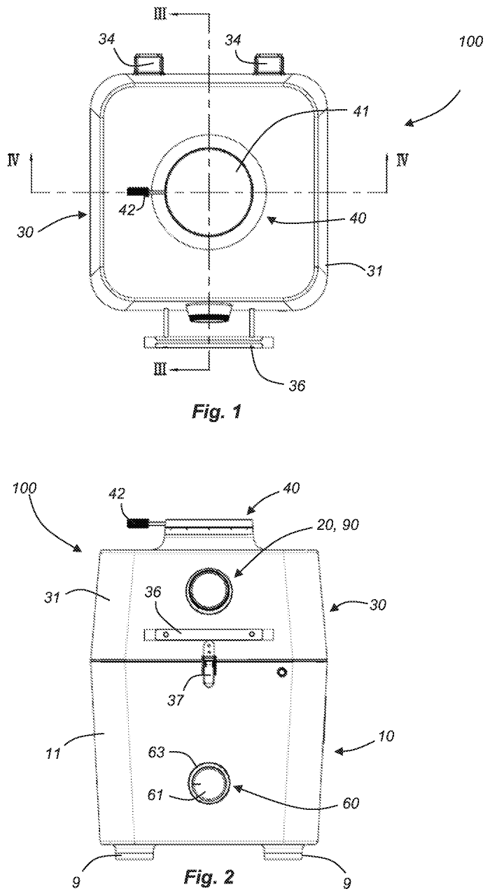

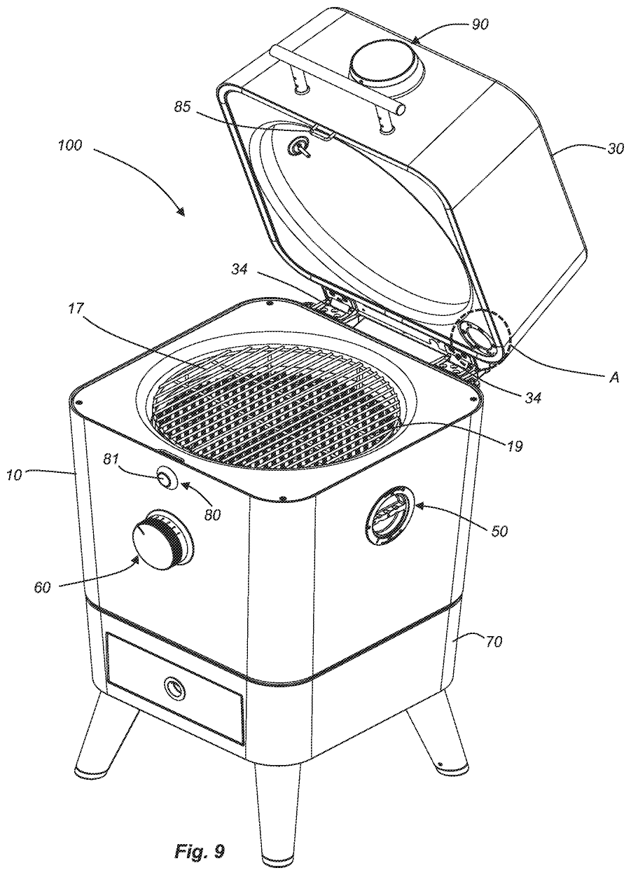

With reference firstly to FIGS. 1 to 4 of the drawings, a solid-fuel cooker 100 according to a preferred embodiment of invention in the form of a barbecue grill oven or smoker oven for outdoor use is shown in a variety of views. The cooker 100 comprises a body 10 and a hood 30 in hinged connection with the body 10 and movable between a closed position (as shown) and an open position (seen later in FIG. 9).

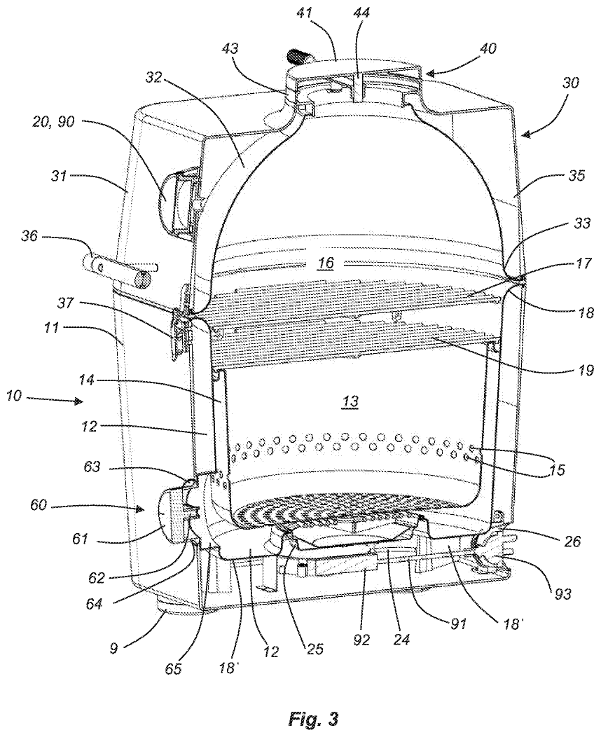

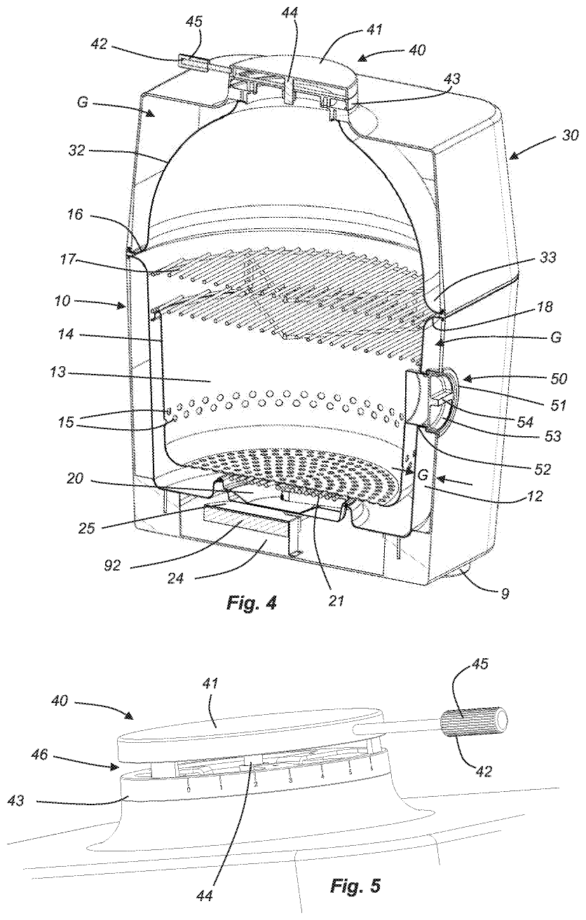

As best seen in drawing FIGS. 3 and 4, the body 10 comprises an outer shell 11 which forms an exterior housing of the cooker 100, and an inner shell 12 which encloses or surrounds a fuel chamber 13 that is configured to act as a firebox for combustion of solid fuel, such as wood, charcoal, briquettes or the like (not shown). In this regard, a fuel support structure configured as a metal basin or bucket 14 is arranged in the fuel chamber 13 within the inner shell 12 for holding the solid fuel. The basin or bucket 14 is perforated with a series of holes 15 to permit airflow to the fuel held or supported therein. A cooking zone 16 is spaced above the fuel chamber 13 for receiving food items to be cooked. To this end, the cooking zone 16 includes a metal grating or grille 17 upon which food items (not shown) may be placed for cooking.

The inner shell 12 of the body 10 has the form of a tub or basin and is housed within and is spaced from the outer shell 11 such that the exterior of the cooker 100 is thermally isolated or insulated from the fuel chamber 13. In particular, the tub-like inner shell 12 is supported within the outer shell 11 along an upper peripheral rim or edge 18 thereof and around a periphery 18′ of its base so that at least about 95 percent of an outer surface area of the inner shell 12 is spaced from outer shell 11. In this way, a gap G of at least about 10 mm is provided between the inner shell 12 and the outer shell 11 by the spaced arrangement and this gap may optionally be at least partially filled with a suitable thermal insulation material rated to temperatures in the range of 200° C. to 500° C. As a result, the outer shell 11 is thermally isolated or insulated from the fuel chamber 13, such that a user may touch the outer shell 11 when the cooker 100 is in normal use without the risk of a severe burn. This is highly desirable for protecting the user and children during use of the cooker 100. The outer shell 11 is typically comprised of metal and may be formed from sheet metal or may be die cast. Similarly, the inner shell 12 and the fuel bucket 14 are also typically comprised of metal and are preferably formed from sheet metal. Examples of suitable metals for the outer shell 11, the inner shell 12, and the basin or bucket 14 include both aluminium and steel, although aluminium is preferred for its relatively low density; i.e. as a light-weight material.

As is apparent from FIG. 3 of the drawings, the cooking zone 16 may be separated from the fuel chamber 13 by a heat shield or heat distributor 19 which extends over and substantially covers an upper opening of the fuel chamber 13 below the metal grating or grille 17. The heat shield or distributor 19 is provided in the form of a plate member, preferably comprised of stone or of metal, which operates to absorb heat generated from the combustion of the solid fuel in the fuel chamber 13 and to transmit (e.g. radiate) that heat in a distributed or relatively uniform manner over the area of the cooking zone 16. The metal grating or grille 17 may include legs 21 upon which it stands in a predefined spaced relation to the heat shield or heat distributor 19.

The cooker 100 includes an electric ignition system 20 in the body 10 for igniting solid fuel supported in the fuel chamber. The electric ignition system 20 includes at least one electric heating element 21 which is mounted within the inner shell 12 and located in or adjacent the fuel chamber 13 just below and/or in contact with the solid fuel basin or bucket 14 for heating and igniting the solid fuel supported therein. This ignition system 20 is described in detail in the co-pending Australian Patent Application No. 2017232161 entitled “Cooker with ignition system for solid fuel”, the contents of which are incorporated herein by reference. For this reason, the various features and operation of this ignition system 20 will not be explained here in detail. It will be noted, however, that the ignition system 20 typically comprises an electric cable 91 for connection to an electrical power supply socket to supply electrical energy to the heating element 21 of the ignition system. The electric cable 91 is wound on a spool 92, which is mounted in a recess 24 below the fuel chamber 13 in the space between the inner shell 12 and the outer shell 11. Heat shielding 25 is preferably provided around the recess 24 to prevent heat damage to the cable during use of the cooker. The cable spool typically has a torsional bias for retracting the cable such that an electrical plug 93 of the cable resides within a recess 26 formed in the bottom of the outer shell 11 of the body 10 when not in use. A latch mechanism such as a pawl and ratchet allows for unwinding of the cable whilst holding against the torsional bias to prevent retraction of the cable upon release. The latch mechanism includes a user operated release actuator for disengaging the latch to allow the torsional bias to effect cable retraction. In one form the user operated release actuator is a button connected to the latch to enable disengagement thereof. Alternatively, the user operated release actuator may be incorporated into the latch mechanism and spool such that disengagement of the latch may be accomplished with a further short pull of the cable.

The cooker 100 further comprises an electronic control system 90 for controlling and/or monitoring operation of the cooker. This control system 90 is operatively connected to the ignition system 20 and configured to deactivate the electric heating element 21 after a predetermined period of time has elapsed following its activation, and/or if the temperature exceeds a predetermined threshold, in order to avoid over-heating and unnecessary power consumption. The predetermined period of time is typically in the range of about 5 minutes to about 10 minutes. The cooker 100 will typically include one or more temperature sensors as shown in FIGS. 9 & 14 for sensing the temperature of particular parts of the cooker; e.g. two temperature sensors or probes may be incorporated or fixed in the hood 30 for sensing the temperature in the cooking zone. The cooker 100 may include one or more additional temperature sensors or probes which are moveable (i.e. non-fixed) to be employed on food items. For instance, at least one temperature sensing probe may be adapted for insertion into a food item to monitor an internal temperature thereof. The temperature sensors are operatively associated with the control system, which is configured to monitor the temperatures sensed by each temperature sensor and provide information from the sensors to the user; e.g. via a display device. The control system 90 may also be configured to relay data to a personal electronic device of a user, such as a mobile phone or a tablet, e.g. via a Bluetooth™ chip provided in the circuitry of the control system 90. In this way, the data allows a user to monitor and/or be alerted to changes in the conditions of the cooker 100 and/or of the food items in the cooking zone 16 (e.g. the ignition sequence, an ambient temperature, a cooker temperature and/or food temperature) remotely on a mobile phone or tablet, if the user is temporarily away from the cooker 100. For instance, a program or “App” on the personal electronic device of a user may present data from the control system to provide on the fly information regarding the ignition sequence notifying the user by means of for instance, an audible signal, of when the cooker is ready to use and/or achieved a predetermined temperature. In still further embodiments, the control system may be configured to receive and initiate operational instructions relayed from the personal electronic device of a user.

Referring further to FIGS. 1 to 4 of the drawings, like the body 10, the hood 30 of the cooker 100 comprises a hood outer shell 31 forming part of the exterior housing of the cooker and a hood inner shell 32 for covering or enclosing the cooking zone 16 in the closed position. The hood inner shell 32 is domed and extends upwards into the hood outer shell 31, supported along or around its lower peripheral rim or edge 33. As is the case with the body 10, the hood inner shell 32 is spaced from the hood outer shell 31 to thermally isolate or insulate the exterior of the cooker 100—this time from the cooking zone 16, and this spaced arrangement of the hood outer and inner shells 31, 32 again provides an air gap G between them of at least about 10 mm over at least about 95 percent of an outer surface area of the hood inner shell 32. The material and fabrication technique for the hood outer shell 31 generally corresponds to that for the outer shell 11 of the body 10, and the material and fabrication technique for the hood inner shell 32 generally corresponds to that of the inner shell 12 of the body 10. As apparent from FIGS. 2 to 4, in the closed position the hood outer shell 31 forms or presents a uniform or continuous outer profile with the outer shell 11 of the body 10—thus producing a uniform or continuous exterior for the cooker 100.

As can be seen in FIG. 1, the hood 30 is connected to the body 10 of the cooker 10 via hinges 34 which enable the hood 30 to pivot through an angle of about 90 degrees between the closed position shown and an open position (not shown). The hinges 34 interconnect a rear wall 35 the hood outer shell 31 and a rear wall of the outer shell 11 of the body 10. A handle 36 is provided at a front side of the hood 30 for moving (i.e. lifting or lowering) the hood 30 between the closed and open positions. A toggle latch 37 is provided below the handle 36 for securing the hood 30 in the closed position. By operating to lock the hood 30 in the closed position, the toggle latch 37 acts as a safety device making it more difficult for children to open the cooker 100 while it is in use. In this regard, the toggle latch 37 can be designed to require a particular degree of strength beyond the capacity of most small children. Alternatively, or in addition, it may be designed to require a level of sophistication or dexterity in operation (e.g. depression of the hood 30 to unlatch) that is beyond the capacity of most small children.

Referring again to drawing FIGS. 3 and 4, as well as to drawing FIG. 5, the hood inner shell 32 is domed and extends upwards into the hood outer shell 31, where it communicates with a chimney assembly 40 that is arranged upstanding on the hood 30. The chimney assembly 40 includes a rotatable cap member 41 and a control handle 42 extending from it. The cap member 41 is mounted to a base member 43 of the chimney assembly via a threaded spindle or shaft 44. Thus, when a user grasps an insulated rubber grip 45 at an end of the control handle 42 and turns the control handle 42 to rotate the cap member 41 on the threaded spindle or shaft 44, the user is thereby able to progressively raise or lower the cap member 41 relative to the base member 43 and so progressively open or close one or more outlet vent apertures 46 in sides of the chimney assembly 40 below the cap member 41; i.e. between the cap member 41 and base member 43. The control handle 42 may be rotatable through an angle of about 180 degrees between fully open and fully closed positions for the outlet vent apertures 46. As is shown in FIG. 5, the chimney assembly is marked with indicia which provide a relative reference to the user of the position of the handle between the fully open and fully closed positions corresponding to the outlet vent apertures 46. In this embodiment the indicia is provided as an evenly spaced scale and reference marker printed on a peripheral circumferential segment of the chimney cap member 41 and base member 43. Consecutive numbers 0 through 6 reference the degree of opening of the vents whereby number 0 corresponds to fully closed vent apertures and number 6 corresponds to fully open vent apertures. In this way the user can instantly recognize, set and recall ventilation settings of the chimney assembly. Furthermore, the vent settings may be referenced in user and cooking guides for simply and clearly conveying operating instructions pertaining to ventilation.

In one embodiment, the chimney assembly includes a grease filter to filter gases rising through the cooker and exiting the outlet vents. The filter also prevents the outlet from becoming clogged with fat/oils residue. The filter is a mesh type baffle filter and may be formed of for instance, metal such as aluminum and/or carbon or charcoal. Suitably the filter is removable for replacement and/or cleaning.

As can be seen in FIG. 4, the body 10 of the cooker 100 further includes a fuel loading port 50 for introducing solid fuel into the fuel chamber 13 during operation of the cooker 100. To this end, the fuel loading port 50 comprises a first re-fueling opening 51 formed through a side wall of the outer shell 11 and a second re-fueling opening 52 (aligned with first re-fueling opening 51) that is formed through a side wall of the inner shell 12 providing access to the fuel chamber 13. The fuel loading port 50 further includes a removable closure 53 in the manner of a plug which is configured to be inserted into and to close both the first re-fueling opening 51 as well as the second re-fueling opening 52 when the fuel loading port 50 is not being used. In this way, the plug-like closure 53 is configured to promote and maintain the thermal isolation or insulation between the outer and inner shells 11. 12 of the cooker body 10. Because the plug-like closure 53 provides a physical connection across the air gap G, however, the outer part of the plug-like closure 53, which includes a handle 54 to be grasped in use is preferably comprised of a highly thermally insulating material, such as a polymer plastic or rubber or the like. The plug-like closure 53 may be movable in the first re-fueling opening 51 (e.g. rotatable through about 90 degrees) between a latched position in which the plug 53 cannot be pulled out of the port 50, and a released position in which it can be pulled out of the port 50 to access the fuel chamber 13 for re-fueling. As will be appreciated, the fuel basin or bucket 14 will typically have an opening aligned with the first re-fueling opening 51 and the second re-fueling opening 52 so that the solid fuel introduced through the fuel loading port 50 may directly enter the fuel basin or bucket 14.

With reference to drawing FIG. 3, it will be noted that the body 10 of the cooker 100 also includes an air inlet assembly 60 in a side wall of the outer shell 11 for providing and regulating an airflow to the fuel chamber 13. The air inlet assembly 60 includes a rotatable cap member 61 mounted on a threaded spindle or shaft 62 (i.e. in a similar manner to the cap member 41 of the chimney assembly 40) which is rotatable relative to a base member 63 to progressively open or close one or more inlet vent apertures 64 formed between the cap member 61 and base member 63. The outer parts of the cap member 61 to be handled by a user are desirably fabricated from a highly thermally insulating material, such as a polymer plastic or rubber or the like. The air inlet assembly 60 further includes an airflow duct or channel 65 formed between the outer shell 11 and the inner shell 12 which provides communication between the inlet vent apertures 64 and the fuel chamber 13. The cap member 61 is rotatable through an angle of about 180 degrees to move between fully open and fully closed positions for the inlet vent apertures 64. With both the chimney assembly 40 and the air inlet assembly 60, a user can carefully regulate the amount of airflow through the fuel chamber 13 and, therefore, the rate of combustion of the fuel during use of the cooker 100. While not shown in the figures, the air inlet assembly is marked with indicia which provide a relative reference to the user of the position of the cap member between the fully open and fully closed positions corresponding to the inlet vent apertures 64. In this embodiment the indicia is provided as an evenly spaced scale and reference marker printed on a peripheral circumferential segment of the rotatable cap member 61 and base member 63 in a similar manner to the chimney assembly 40.

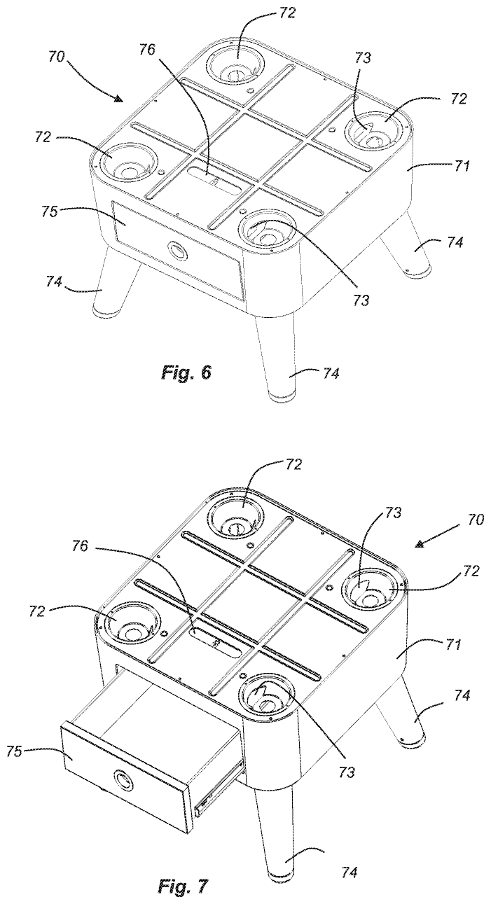

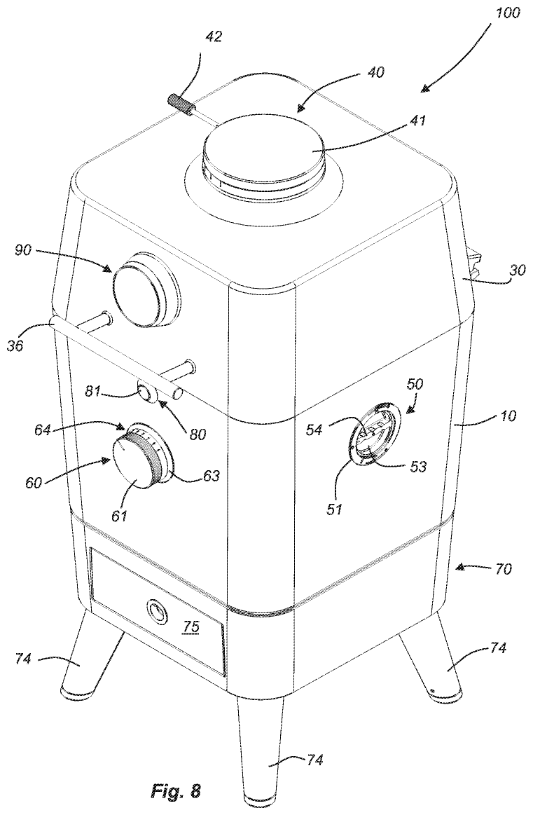

Referring now to FIGS. 6 and 7 of the drawings, a base unit 70 for a solid-fuel cooker 100 of the type shown in FIGS. 1 to 4 is shown. The base unit 70 is designed for supporting and elevating the body 10 of the cooker 100 to provide an embodiment of the cooker 100 generally corresponding to that shown in drawing FIGS. 8 and 9, albeit without the casters or rollers shown there. To this end, the base unit 70 includes a generally box-like frame 71 having recesses 72 formed in an upper surface thereof for receiving respective footings 9 provided externally on a bottom of the outer shell 11 of the body 10. The recesses 72 each include latching elements 73 that are designed to cooperate and engage with complementary notches formed in the footings 9 of the body 10 to securely lock the body 10 to the base unit 70 when the footings 9 are inserted into those recesses 72. The base unit 70 includes legs 74 depending from the box-like frame 71 for supporting and elevating the body 10 of the cooker 100 on an outdoor surface, such as a terrace or patio. The box-like frame 71 also includes a drawer 75 suitable for storing cooking utensils. It will be noted from FIG. 6 that the that latching elements 73 are in a latching position extended into the recesses 72 and the display 76 on the upper surface of the box-like frame 71 shows the word “Locked”. To withdraw or unlock the latching elements 73, the drawer 75 is opened so that a user may access a release lever or mechanism (not shown) inside the frame 71 to withdraw the latching elements 73 from the recesses 72. The display 76 on the upper surface of the box-like frame 71 then shows the word “Unlocked”. The body 10 of the cooker 100 seen in FIGS. 1 to 4 may then be lowered onto the base unit 70 such that its footings 9 are received in the recesses 72. By then closing the drawer 75, the latching elements 73 may be automatically re-activated to the locked or latching state, in which they engage with the footings 9 and lock the body 10 to the base unit 70. In this way, the taller or more elevated embodiment of the solid-fuel cooker 100 as shown in FIGS. 8 and 9 may be provided.

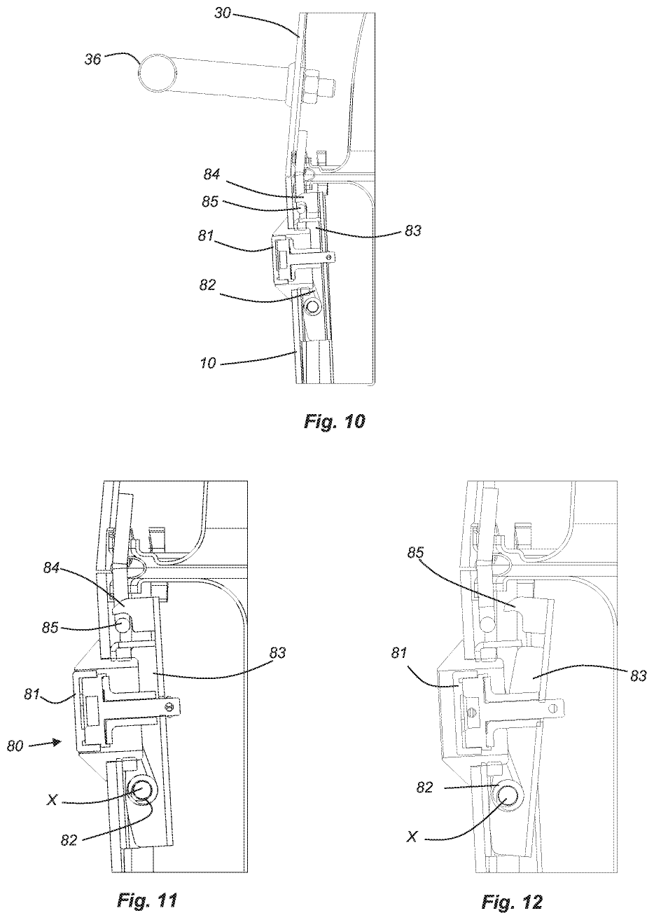

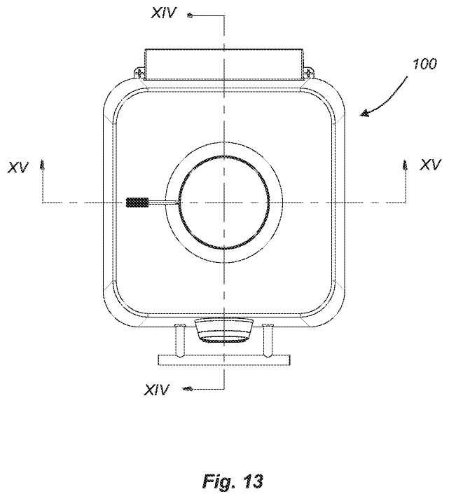

Instead of a toggle latch 37, the cooker 100 shown in FIGS. 8 and 9 has an internal latch mechanism 80 illustrated in FIGS. 10 to 12 for securing the hood 30 in the closed position. In this way, the cooker 100 of this embodiment has been designed so that moving the hood 30 to the open position requires two-handed operation; i.e. one hand to disengage latch mechanism 80 and one hand to lift the hood 30 via the handle 36 at the same time that the latch mechanism 80 is disengaged. This provides a child-safety function. The latch mechanism 80 is substantially hidden from view and a child cannot simply lift or open the hood of the cooker via the handle 36 without simultaneously disengaging the latch mechanism 80. The latch mechanism 80 includes an actuator button 81, which is spring biased via torsion spring 82, and a latch member 83 which pivots about an axis X against the spring bias when the button 81 is pressed. In particular, upon pressing the button 81, the latch member 83 pivots from the position seen in FIGS. 10 and 11 in which a projection 84 at an end of the latch member 83 engages a catch 85 depending from the hood 30 (i.e. the latched state), to the position seen in FIG. 12 in which the projection 84 at the end of the latch member 83 is moved out of engagement with the catch 85 (i.e. the unlatched or released state). Thus, when the actuator button 81 is pressed inwards, the latch member 83 pivots to disengage the latch mechanism 80 and to release the hood 30 for opening.

With reference to FIGS. 8 & 9, the handle 36 is disposed with sufficient spacing and/or orientation with respect to the button 81 such that with a hand on the handle, it is not possible (or at least difficult or unergonomic) to depress the button 81 with the same hand, particularly with the hands of a small child. As shown in FIG. 8, the button is located on the body 10 of the cooker 100 while the handle is located on the hood 30. The spring bias applied to the actuator button 81 via the spring 82 can be selected to be beyond the strength of most small children.

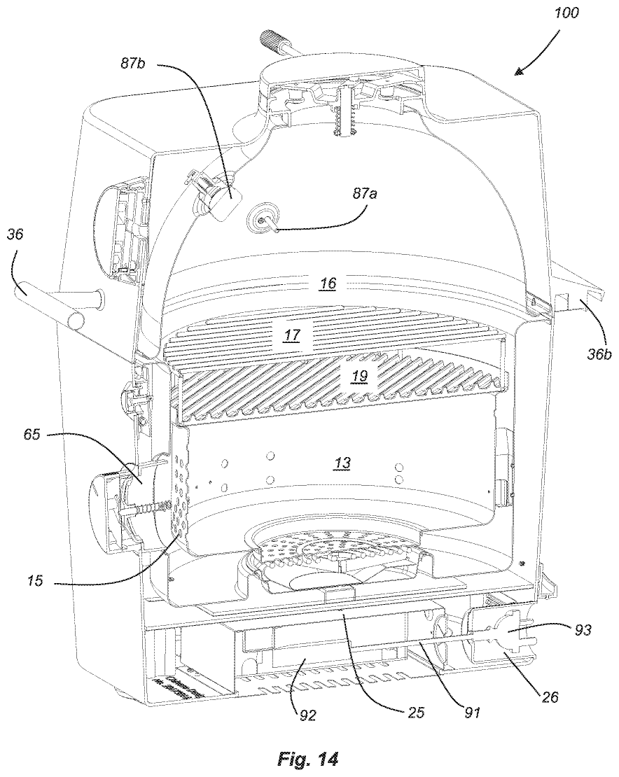

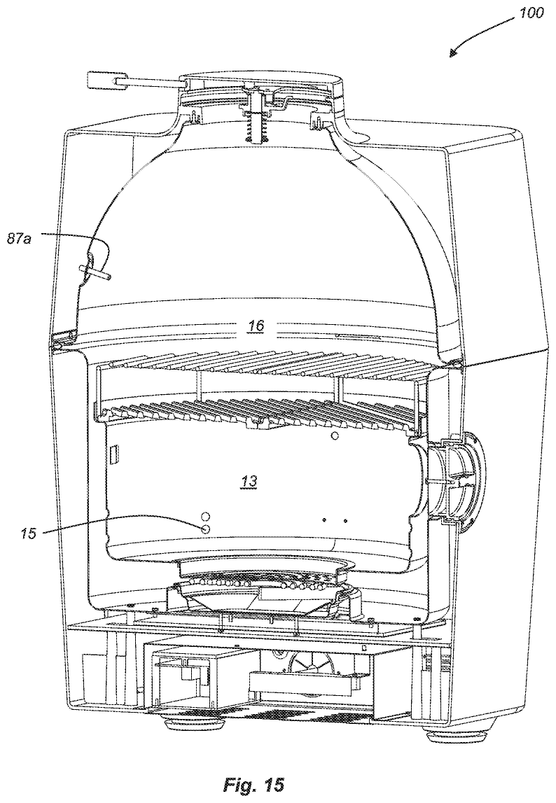

With reference to FIGS. 14 & 15, the holes 15 in the basin or bucket 14 which permit air to enter the fuel chamber 13 are concentrated in the basin 14 adjacent the airflow channel 65 formed between the outer shell 11 and the inner shell 12. Positioning holes in this location provides air a direct route into the chamber 13 aiding in efficient combustion of fuel.

In this embodiment, temperature sensors 87a and 87b are incorporated or fixed in the hood 30 for sensing the temperature at different locations in the cooking zone 16. The sensors are operatively associated with the control system, which calculates an average or weighted average temperature and conveys it to the user via the display device or wireless connection.

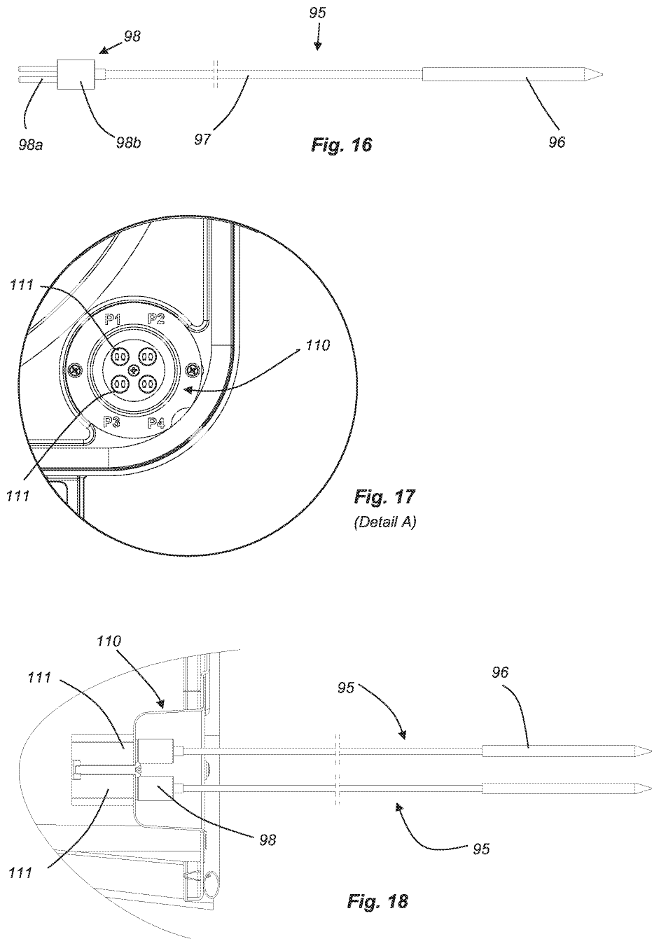

As seen in FIG. 16, the cooker 100 may include one or more additional temperature sensors or probes 95 which are moveable (i.e. non-fixed). For instance, the temperature sensing probe may be adapted for insertion into a food item to monitor an internal temperature of the item, particularly during cooking. The probe includes a food insertion portion 96 at a distal end which is connected by a flexible cable 97 to a terminal connector in the form of a plug 98 at a proximal end for electrically coupling with the cooker and more particularly, the cooker control system. In this embodiment the plug includes electrical contacts 98a embedded within a ceramic or other heat resistant plug body 98b. In this way the probe is formed primarily of ceramic and metal materials enabling it to operate temperatures in the range of 200° C. to 500° C.

One or more connection ports 111 are provided within the cooking zone, for receiving the plug 98 of the probe 95 and interfacing with the control system. As can be seen with reference to FIG. 9, connection ports 111 are disposed within a recess 111 in the hood 30. In the detail illustrations shown in FIGS. 17 and 18, four probe connection ports 111 are provided enabling up to four probes to be used simultaneously. Each port is marked either by indicia, colour coding or the like so it can be identified by the user. For instance, as seen in FIG. 17, the four ports are numbered P1, P2, P3 and P4 and the temperatures recorded by each respective probe of a port are similarly identified by the control system.

Furthermore, the handle 36 and latch mechanism 80 are constructed to allow lifting and repositioning of the cooker. With the hood 30 closed and the latch mechanism in the latched state, the handle 36 may be used to lift the cooker. Suitably, the rear of the cooker includes a rear lifting formation 36b or handle so that the cooker may be lifted from front and rear co-operatively. As shown in FIG. 14, the rear handle is formed as an extension of the hood adjacent the hinges 34 thereby providing an overhang to enable lifting. Alternatively, a handle maybe attached to the hood or the body. Both the front and rear handles are configured to be sufficiently robust to support the weight of the cooker during lifting and maneuvering.

Although specific embodiments of the invention are illustrated and described herein, it will be appreciated by those of ordinary skill in the art that a variety of alternative and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first”, “second”, “third”, etc. are used merely as labels, and are not intended to impose numerical requirements on or to establish a certain ranking of importance of their objects.

1. The solid-fuel cooker of claim 6,
wherein the body comprises an outer shell forming an exterior housing of the cooker, and an inner shell encompassing the fuel chamber, wherein the inner shell is housed within the outer shell and is spaced from the outer shell to thermally isolate or insulate the fuel chamber from the exterior housing of the cooker.

2. The solid-fuel cooker of claim 1, wherein the inner shell is spaced from the outer shell over at least 95 percent of its outer or external surface area to thermally isolate or insulate the fuel chamber from the exterior housing of the cooker.

3-4. (canceled)

5. The solid-fuel cooker of claim 6, further comprising an ignition system for igniting solid fuel supported in the fuel chamber, wherein the ignition system comprises at least one electric heating element mounted within the body for heating solid fuel supported in the fuel chamber, wherein the at least one electric heating element is located in or adjacent the fuel chamber.

6. A solid-fuel cooker, such as a barbecue, oven, or smoker for outdoor use, the cooker comprising:
a body having or enclosing a fuel chamber configured to act as a firebox for combustion of solid fuel, such as wood, charcoal or briquettes;
a fuel support for supporting the solid fuel in the fuel chamber;
a cooking zone spaced above the fuel chamber for receiving food items to be cooked;
a hood which is connected to the body and movable between a closed position, in which it covers and encloses the cooking zone, and an open position, in which access to the cooking zone is provided;
an electronic control system for controlling and/or monitoring operation of the cooker; and
at least one temperature sensor for sensing a temperature within the cooker, the at least one temperature sensor being operatively associated with the control system control.

7. The solid-fuel cooker of claim 5, wherein the control system is operatively connected to the ignition system and configured to deactivate the at least one electric heating element after a predetermined period of time has elapsed following its activation and/or if a temperature exceeds a predetermined threshold.

8. (canceled)

9. The solid-fuel cooker of claim 6, wherein the control system is configured to transfer data to, or to communicate with, a personal electronic device of a user, such as a mobile phone or a tablet, to allow the user to monitor a state of the cooker, such as ambient temperature(s), cooker temperature(s) and/or food item temperature(s) remotely via the personal electronic device.

10. The solid-fuel cooker of claim 6, wherein the hood comprises a hood outer shell forming part of an exterior housing of the cooker and a hood inner shell for covering and enclosing the cooking zone, the hood inner shell being spaced from the hood outer shell to thermally isolate the cooking zone from the exterior housing of the cooker.

11. The solid-fuel cooker of claim 10, wherein the hood inner shell is spaced from the hood outer shell over at least 95 percent of its outer or external surface area to thermally isolate the exterior housing of the cooker from the cooking zone.

12. (canceled)

13. The solid-fuel cooker of claim 10, wherein the hood comprises an upstanding chimney assembly with a rotatable control member that is operable to progressively open or close one or more outlet vent apertures in the chimney assembly, said chimney assembly including a cap that is rotatable via the control member to progressively open or close the one or more outlet vent apertures provided in lateral sides of the chimney assembly below the cap.

14-15. (canceled)

16. The solid-fuel cooker of claim 6, further comprising an internal latch mechanism for securing the hood in the closed position, whereby movement of the hood to the open position requires two-handed operation to disengage the latch mechanism and to lift or move the hood simultaneously.

17. The solid-fuel cooker of claim 6, wherein the body includes a fuel loading port comprising a first re-fueling opening formed through a side wall of the body and providing access to the fuel chamber for introducing solid fuel into the fuel chamber during operation of the cooker, wherein the fuel loading port includes a removable closure for closing the first re-fueling opening when the fuel loading port is not in use.

18. (canceled)

19. The solid-fuel cooker of claim 6, wherein the body further comprises an air inlet assembly having an airflow channel in a side wall of the body and a rotatable control member that is operable to progressively open or close one or more inlet vent apertures for providing airflow to the fuel chamber, and wherein the rotatable control member is provided as a cap or closure which covers an end of the airflow channel at the side wall and is rotatable to progressively open or close the one or more inlet vent apertures.

20. The solid-fuel cooker of claim 19, wherein the air inlet assembly includes an airflow channel through the side wall of the body providing communication between the one or more inlet vent apertures and the fuel chamber, wherein the rotatable control member covers an end of the airflow channel at the side wall of the body and is rotatable through an angle of about 180 degrees to about 360 degrees, to progressively open or close the one or more inlet vent apertures.

21-22. (canceled)

23. The solid-fuel cooker of claim 6, wherein the control system is configured to convey temperature data sensed by the at least one temperature sensor to a user via a display device.

24. The solid-fuel cooker of claim 6, wherein the at least one temperature sensor is incorporated or fixed in the hood for sensing a temperature in the cooking zone.

25. The solid-fuel cooker of claim 6, including a plurality of said at least one temperature sensors, each sensor being operatively associated with the control system, which calculates an average or weighted average temperature based on temperature data from said plurality of temperature sensors.

26. The solid-fuel cooker of claim 6, wherein at least one connection port is provided within the cooking zone, for operative connection with a temperature sensor and wherein said at least one connection port is operatively connected to the control system.

27. The solid-fuel cooker according to claim 26, wherein the at least one connection port is disposed in the hood.

28. The solid-fuel cooker of claim 26, wherein the temperature sensor includes a temperature sensor probe having a food insertion portion at a distal end which is connected to a terminal connector at a proximal end for electrically coupling with a respective connection port.

29. The solid-fuel cooker of claim 26, wherein a plurality of connection ports are provided within the cooking zone, each port for operative connection with a respective temperature sensor.

30. The solid-fuel cooker of claim 16, wherein the latch mechanism includes an actuator button for disengaging the latch and wherein the hood includes a handle for lifting the hood, said button and said handle being spaced so as to prevent simultaneous activation of the button and lifting the hood one-handed.
